(19) United States
(12) Patent Application Publication
(10) Pub. No.: US 2025/0178863 A1
(43) Pub. Date: Jun. 5, 2025

(54) METHOD, AN ELEVATOR COMPUTING UNIT, AND A LOAD ESTIMATION SYSTEM FOR PRODUCING LOAD DATA OF AN ELEVATOR CAR OF AN ELEVATOR SYSTEM

(71) Applicant: KONE Corporation, Helsinki (FI)

(72) Inventors: Henri WENLIN, Helsinki (FI); Ari KATTAINEN, Helsinki (FI)

(73) Assignee: KONE Corporation, Helsinki (FI)

(21) Appl. No.: 19/045,426

(22) Filed: Feb. 4, 2025

Related U.S. Application Data
(63) Continuation of application No. PCT/FI2022/050611, filed on Sep. 12, 2022.

(51) Int. Cl. B66B 1/34; B66B 1/06; B66B 5/00

(52) U.S. Cl. CPC B66B 1/3476; B66B 1/06; B66B 5/0018

(57) ABSTRACT

The invention relates to a method for producing load data of an elevator car of an elevator system. The method comprises: obtaining condition data comprising at least one loading condition parameter being affected by the load of the elevator car, wherein the condition data is obtained during a loading event of the elevator car at a loading landing or during an elevator car movement cycle between a loading landing and a destination landing; using the obtained condition data as input data of a reinforcement learning model; processing the input data with the reinforcement learning model to produce output data comprising the load data of the elevator car representing an estimate of the load of the elevator car; and using the produced load data of the elevator car in controlling of the elevator system and/or in condition monitoring of the elevator car. The invention relates also to an elevator computing unit, a load estimation system, a computer program product, and a computer-readable medium for producing load data of an elevator car of an elevator system.

### TECHNICAL FIELD

The invention concerns in general the technical field of elevator systems. Especially the invention concerns monitoring elevator systems.

### BACKGROUND

Elevator systems typically an elevator car and an elevator hoisting motor arranged to drive the elevator car along an elevator shaft between a plurality of landings. The elevator system may typically further comprise one or more internal sensor devices for providing various operation data of the elevator system. The operation data may comprise e.g. load data of the at least one elevator car. For example, the elevator system may comprise a load weighting device arranged to the elevator car for providing the load data of the elevator car. However, there may exist situations, where there is no access to an elevator control system of the elevator system and thus the load data of the elevator car is not available, for example in case remote monitoring or maintenance of third-party elevator systems. Alternatively or in addition, there may exists situations, where an alternative way to define the load data of the elevator car may be needed. High quality sensor measurements are playing crucial role in elevator system monitoring. For example, accuracy, resolution, repeatability, and consistency of measurement over lifetime may be considered as critical for quality of the sensor measurements. These requirements may often lead to sensor structures and sensor manufacturing processes which are highly sophisticated and sensitive for tolerance errors, which in turn may result to high sensor prices and tight requirements for installation and calibration processes of the sensors.

Therefore, there is a need to develop further solutions for defining load data of an elevator car.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, an elevator computing unit, a load estimation system, a computer program, and a computer-readable medium for producing load data of an elevator car of an elevator system. Another objective of the invention is that the method, the elevator computing unit, the load estimation system, the computer program, and the computer-readable medium for producing load data of an elevator car of an elevator system enhance measurements of the load of the elevator car.

The objectives of the invention are reached by a method, an elevator computing unit, a load estimation system, a computer program, and a computer-readable medium as defined by the respective independent claims.

According to a first aspect, a method for producing load data of an elevator car of an elevator system is provided, wherein the method comprises: obtaining condition data comprising at least one loading condition parameter being affected by the load of the elevator car, wherein the condition data is obtained during a loading event of the elevator car at a loading landing or during an elevator car movement cycle between a loading landing and a destination landing; using the obtained condition data as input data of a reinforcement learning model; processing the input data with the reinforcement learning model to produce output data comprising the load data of the elevator car representing an estimate of the load of the elevator car; and using the produced load data of the elevator car in controlling of the elevator system and/or in condition monitoring of the elevator car.

The method may further comprise obtaining measured load data of the elevator car representing a measured load of the elevator car from an elevator drive unit after a departure of the elevator car from the loading landing and using the obtained measured load data of the elevator car to train the reinforcement learning model.

The method may further comprise providing the trained reinforcement learning model to an external entity for further development of the trained reinforcement learning model and/or for providing the trained reinforcement learning model to one or more other elevator systems having the same configuration and conditions as the elevator system.

The at least one loading condition parameter may comprise a rope elongation value, a hoisting machine bedplate to a hoisting machine body distance value, and/or a hoisting machine tilt value.

The condition data may further comprise at least one additional condition parameter.

The at least one additional condition parameter may comprise landing data, an ambient temperature of the elevator car, an ambient humidity of the elevator car, and/or a number of starts of the elevator car.

The loading event may start from an opening of a door of the elevator car and the loading event may end to a closing of the door of the elevator car, an opening of brakes, or an activating a torque control to a drive unit.

According to a second aspect, an elevator computing unit for producing load data of an elevator car of an elevator system is provided, wherein the elevator computing unit comprises: a processing unit comprising at least one processor; and a memory unit comprising at least one memory including computer program code; wherein the at least one memory and the computer program code are configured to, with the at least one processor, cause the elevator computing unit to perform: obtain condition data comprising at least one loading condition parameter being affected by the load of the elevator car, wherein the condition data is obtained during a loading event of the elevator car at a loading landing or during an elevator car movement cycle between a loading landing and a destination landing; use the obtained condition data as input data of a reinforcement learning model; process the input data with the reinforcement learning model to produce output data comprising the load data of the elevator car representing an estimate of the load of the elevator car; and utilize the produced load data of the elevator car in controlling of the elevator system and/or in condition monitoring of the elevator car.

The elevator computing unit may further be configured to: obtain measured load data of the elevator car representing a measured load of the elevator car from an elevator drive unit after a departure of the elevator car from the loading landing, and use the obtained measured load data of the elevator car to train the reinforcement learning model.

The elevator computing unit may be configured to provide the trained reinforcement learning model an external entity for further development of the trained reinforcement learning model and/or for providing the trained reinforcement learning model to one or more other elevator systems having the same configuration and conditions as the elevator system.

The at least one loading condition parameter may comprise a rope elongation value, a hoisting machine bedplate to a hoisting machine body distance value, and/or a hoisting machine tilt value.

The condition data may further comprise at least one additional condition parameter.

The at least one additional condition parameter may comprise landing data, an ambient temperature of the elevator car, an ambient humidity of the elevator car, and/or a number of starts of the elevator car.

The loading event may start from an opening of a door of the elevator car and the loading event may end to a closing of the door of the elevator car, an opening of brakes, or an activating a torque control to a drive unit.

According to a third aspect, a load estimation system for producing load data of an elevator car of an elevator system is provided, wherein the load estimation system comprises: at least one sensor device configured to provide condition data comprising at least one loading condition parameter being affected by the load of the elevator car, and an elevator computing unit as discussed above.

According to a fourth aspect, a computer program product is provided, wherein the computer program product comprises instructions which, when the program is executed by a computer, cause the computer to carry out the method as discussed above.

According to a fifth aspect, a computer-readable medium is provided, wherein the computer-readable medium comprises instructions which, when executed by a computer, cause the computer to carry out the method as discussed above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system.

FIG. 2A illustrates schematically an example of a load estimation system.

FIG. 2B illustrates schematically another example of a load estimation system.

FIG. 3 illustrates schematically an example of a method for producing load data of an elevator car of an elevator system.

FIG. 4 illustrates schematically an example of an example of producing load data by applying a reinforcement learning model.

FIG. 5 illustrates schematically another example of the method.

FIG. 6 illustrates schematically an example of training of a reinforcement learning model by using measured load data.

FIG. 7 illustrates schematically an example of components of an elevator computing unit.

### DESCRIPTION OF THE EXEMPLIFYING EMBODIMENTS

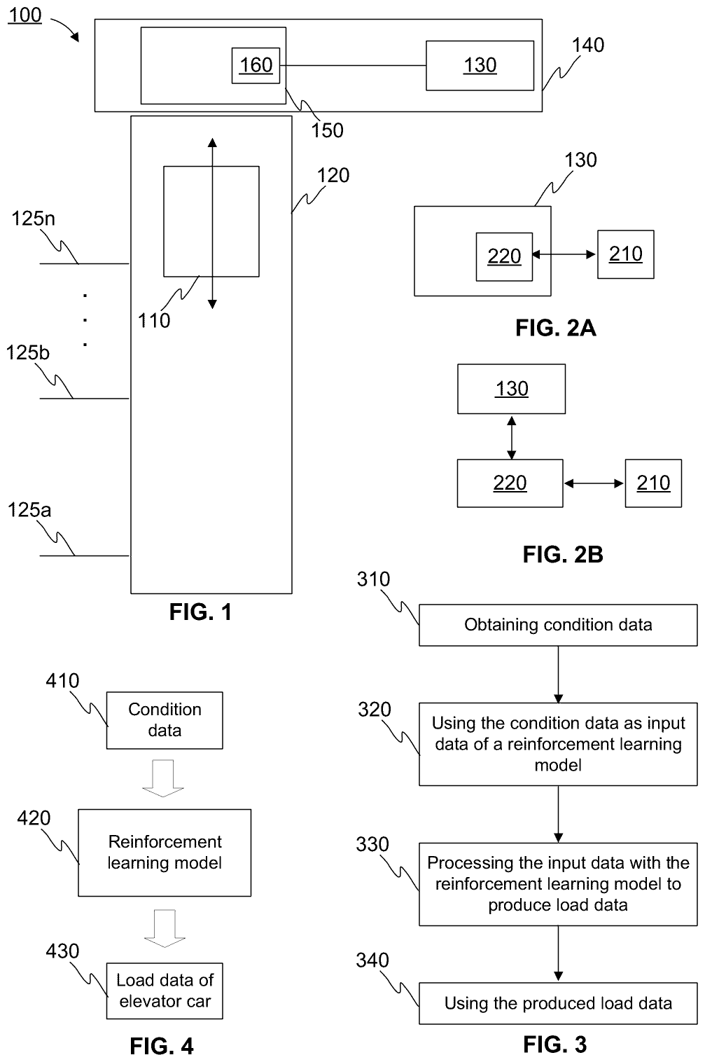

FIG. 1 illustrates schematically an example of an elevator system 100. The elevator system 100 comprises at least one elevator car 110 configured to travel along a respective elevator shaft 120 between a plurality of landings 125a-125n. The elevator system 100 of the example of FIG. 1 comprises one elevator car 110 travelling along one elevator shaft 120, however the elevator system 100 may also comprise an elevator group, i.e. group of two or more elevator cars 110 each travelling along a separate elevator shaft 120 configured to operate as a unit serving the same landings 125a-125n. The elevator system 100 further comprises an elevator control unit, e.g. an elevator controller, 130. The elevator control unit 130 may be configured to control the operation of the elevator system 100 at least in part. The elevator control unit 130 may reside e.g. in a machine room 140 or in one of the landings 125a-125n of the elevator system 100. The elevator system 100 further comprises a hoisting machine 150 comprising a hoisting motor 160 arranged to drive the elevator car 110 along the elevator shaft 120. The hoisting machine 150 may further comprise one or more known hoisting machinery entities, such as one or more sheaves, pulleys, and/or brakes, etc., which are not shown in FIG. 1 for sake of clarity. The hoisting machine 150 may be arranged inside the machine room 140 residing above the elevator shaft 120 as illustrated in the example of FIG. 1. Alternatively, the hoisting machine 150 may be located inside the elevator shaft 120 (e.g. in a machine-roomless elevator system). The elevator control unit 130 may comprise a drive unit configured to control the hoisting motor 160 to drive, i.e. move, the elevator car 110 along the elevator shaft 120. The elevator system 100 may further comprise one or more other known elevator related entities, e.g. elevator ropes, user interface devices, safety circuit and devices, elevator door system, etc., which are not shown in FIG. 1 for sake of clarity. The elevator system 100 further comprises a load estimation system 200 (for sake of clarity entities of the load estimation system 200 are not shown in FIG. 1).

FIGS. 2A and 2B illustrate schematically simple examples of the load estimation system 200 for producing load data 430 of an elevator car 110 of the elevator system 100. The load estimation system 200 comprises at least one sensor device 210 for providing condition data 410 and an elevator computing unit 220. In the examples of FIGS. 2A and 2B one sensor device 210 is illustrated, but the load estimation system 200 may also comprise more than one sensor device 210. The at least one sensor device 210 is communicatively coupled to the elevator computing unit 220. The communication between the at least one sensor device 210 and the elevator computing unit 220 may be based on one or more known communication technologies, either wired or wireless. According to an example, the elevator computing unit 220 may for example be the elevator control unit 130 or comprised by the elevator control unit 130 as illustrated in the example of FIG. 2A. According to another example, the elevator computing unit 220 may for example be an external computing unit as illustrated in the example of FIG. 2B. The term “external” in the context of the computing unit means throughout this application a computing unit being external to the elevator system 100. The elevator computing unit 220 implemented as the external computing unit may be located on-site and/or off-site. The elevator computing unit 220 implemented as the external computing unit may for example comprise a server, a cloud-based computing unit, remote computing unit, computing circuit, and/or any other computing device or a network of computing devices being external to the elevator system 100. If the elevator computing unit 220 is implemented as the external computing unit, the elevator computing unit 220 may be communicatively coupled to the elevator control unit 130. The communication between the elevator computing unit 220 and the elevator control unit 130 may be based on one or more known communication technologies, either wired or wireless.

Next an example of a method for producing load data 430 of an elevator car 110 of an elevator system 100 is described by referring to FIG. 3. FIG. 3 schematically illustrates the method as a flow chart. The example method of FIG. 3 is described by using only one elevator car 110, but the method may also be applied correspondingly for producing load data 420 of more than one elevator car 110.

At as step 310, the elevator computing unit 220 obtains condition data 410 comprising at least one loading condition parameter being affected by the load of the elevator car 110. As discussed above, the condition data 410 may be provided by the at least one sensor device 210. The elevator computing unit 220 may obtain the condition data 410 from the at least one sensor device 210. The condition data 410 is obtained during a loading event of the elevator car 110 at a loading landing. The loading landing may be any landing of the plurality of landings 125a-125n of the elevator system 100. The loading event may start from an opening of a door of the elevator car 110. The loading event may end to a closing of the door of the elevator car 110, an opening of the brakes of the hoisting machine 150, or activating a torque control to the drive unit. The elevator control unit 130 may for example provide information of the opening of the door of the elevator car 110, information of the closing of the door of the elevator car 110, information of the opening of the brakes of the hoisting machine 150, and/or information of the activating the torque control to the drive unit from the elevator control unit 130. The loading event may comprise the unloading of the elevator car 110 and/or the loading of the elevator car 110 at the loading landing. The obtaining the condition data 410 during the loading event enables that the load data 430 of the elevator car 110 may be defined before a departure of the elevator car 110 from the loading landing. Alternatively or in addition, the obtaining the condition data 410 during the loading event enables that a load weighting device of the elevator car 110 may be replaced by using the method for producing the load data 430 of the elevator car 110 or the method for producing the load data 430 of the elevator car 110 may be used alongside the load weighting device of the elevator car 110 to enhance and adapt the load measurement over the lifetime of the elevator system 100. The replacement of the load weighting device enables reduction of costs and improvement of quality, because there are less parts to break down in the elevator system 100. Alternatively, the condition data 410 is obtained during an elevator car movement cycle between the loading landing and a destination landing. The loading landing may be any landing of the plurality of landings 125a-125n of the elevator system 100 and the destination landing may be any other landing of the plurality of landings 125a-125n of the elevator system 100. The obtaining the condition data during the elevator car movement cycle enables improving the accuracy of the produced load data 430.

The load of the elevator car 110 in not only affecting to itself, but the effect of the load of the elevator car 110 may also be seen in other components and/or parts of the elevator system 100. The at least one loading condition parameter may comprise such a parameter(s) that changes depending on the load of the elevator car 110. For example, the unloading and/or loading of the elevator car 110 during the loading event, for example unloading of one or more passengers and/or freight from the elevator car 110 and/or loading one or more passengers and/or freight to the elevator car 110, causes that a condition parameter at the beginning of the loading event differs from the respective condition parameter at the end of the loading event. The at least one loading condition parameter may comprise an elevator rope elongation value, a hoisting machine bedplate to a hoisting machine body distance value, and/or a hoisting machine tilt value. The at least one sensor device 210 of the load estimation system 200 may comprise at least one sensor device for each loading condition parameter. For example, if the condition data 410 comprises the elevator rope elongation value, the hoisting machine bedplate to the hoisting machine body distance value, and the hoisting machine tilt value, the at least one sensor device 210 of the load estimation system 200 may comprise at least one sensor device configured to provide the rope elongation value, at least one sensor device configured to provide the hoisting machine bedplate to the hoisting machine body distance value, and at least one sensor device configured to provide the hoisting machine tilt value.

The elevator rope elongation value may represent elongation of the elevator ropes. The elevator ropes may be hoisting ropes (i.e. suspension ropes) configured to carry, i.e. suspend, the elevator car 110 so that the elevator car 110 is in one end of the hoisting ropes and a counterweight in the other end of the hoisting ropes. The hoisting ropes elongate depending on the load of the elevator car 110. If the condition data 410 is obtained during the loading event, the elevator rope elongation value may be an elevator rope elongation difference between the opening and the closing of the door of the elevator car 110. The elevator rope elongation difference between the opening and the closing of the door of the elevator car 110 may represent the difference, i.e. subtraction between the elevator rope elongation at the opening of the door of the elevator car 110 and the elevator rope elongation at the closing of the door of the elevator car 110. The at least one sensor device configured to provide the elevator rope elongation value during the loading event may for example be a position sensor device. For example, if the condition data 410 is obtained during the loading event, the elevator rope value may be determined based on a position difference between a first position of the elevator car 110 provided by the position sensor device at the opening of the elevator door of the elevator car 110 and a second position of the elevator car 110 provided by the position sensor device at the closing of the door of the elevator car 110. Alternatively, if the condition data 410 is obtained during the elevator car movement cycle, the elevator rope elongation value may be an elevator rope elongation with a static load during the elevator car movement cycle. The at least one sensor device configured to provide the elevator rope elongation value during the elevator car movement cycle may for example be a visual monitoring device. For example, if the condition data 410 is obtained during the elevator car movement cycle the visual monitoring device may comprise a light source and a line camera, wherein the light is emitted by the light source towards the elevator rope, and the line camera detects a hill and valley representation of the moving rope from the opposite side of the light source, and the elevator rope elongation value may be determined by a distance between hills or valleys.

The hoisting machine bedplate is a platform on which the body of the hoisting machine 150, i.e. the hoisting machine body, is placed. The distance between the hoisting machine bedplate and the hoisting machine body changes depending on the load of the elevator car 110. If the condition data 410 is obtained during the loading event, the hoisting machine bedplate to the hoisting machine body distance value may be a hoisting machine bedplate to a hoisting machine body distance difference between the opening and the closing of the door of the elevator car 110. The hoisting machine bedplate to the hoisting machine body distance difference between the opening and the closing of the door of the elevator car 110 represents the difference, i.e. subtraction, between the distance at the opening of the door of the elevator car 110 and the distance at the closing of the door of the elevator car 110. Alternatively, if the condition data 410 is obtained during the elevator car movement cycle, the hoisting machine bedplate to the hoisting machine body distance value may be a hoisting machine bedplate to a hoisting machine body distance with a static load during the elevator car movement cycle. The at least one sensor device configured to provide the hoisting machine bedplate to the hoisting machine body distance value may for example be a distance sensor device. Non-limiting examples of the distance sensor device may comprise, but is not limited to, a laser distance sensor device, a capacitive distance sensor device, or an inductive displacement sensor device, etc.

The hoisting machine 150 may tilt in relation to the gravitational force. For example, in case of the machine-roomless elevator system 100, the hoisting machine 150 may be tilting towards guide rails, when the load is applied to the elevator car 110. The hoisting machine tilt changes depending on the load of the elevator car 110. If the condition data 410 is obtained during the loading event, the hoisting machine tilt value may be a hoisting machine tilt difference between the opening and the closing of the door of the elevator car 110. The hoisting machine tilt difference between the opening and the closing of the door of the elevator car 110 represents the difference, i.e. subtraction, between the hoisting machine tilt at the opening of the door of the elevator car 110 and the hoisting machine tilt at the closing of the door of the elevator car 110. Alternatively, if the condition data 410 is obtained during the elevator car movement cycle, the hoisting machine tilt value may be a hoisting machine tilt with a static load during the elevator car movement cycle. The at least one sensor device configured to provide the hoisting machine tilt value may for example be a tilt sensor device. Non-limiting examples of the tilt sensor device may comprise, but is not limited to, an inclinometer, a micro-electro-mechanical systems (MEMS)-based sensor device, a fluid-based sensor device, or a potentiometer, etc.

According to an example, the obtained condition data 410 may further comprise at least one additional condition parameter. The at least one additional condition parameter may be independent of the load of the elevator car 110. The at least one additional condition parameter may for example comprise landing data, an ambient temperature of the elevator car 110, an ambient humidity of the elevator car 110, and/or a number of starts of the elevator car 110. The landing data may comprise loading landing information representing the loading landing and/or destination landing information representing the destination landing. According to a non-limiting example, the obtained condition data 410 may comprise at least a combination of the elevator rope elongation value and the loading landing information. This is an advantageous example combination of at least one loading condition parameter and at least one additional condition parameter, because the elevator rope elongation value may depend on the loading landing. The at least one sensor device 210 of the load estimation system 200 may comprise at least one sensor device for each additional condition parameter. Alternatively, at least some of the additional condition parameters may be provided with the same at least one sensor device, e.g. the landing data and the number of starts of the elevator car 110. The at least one sensor device configured to provide the ambient temperature of the elevator car 110 may for example be a temperature sensor device. The at least one sensor device configured to provide the ambient humidity of the elevator car 110 may for example be a humidity sensor device. The at least one sensor device configured to provide the landing data and/or the number of starts of the elevator car 110, may for example comprise an elevator motion control unit and/or a cloud-based unit. The elevator motion control unit and the cloud-based computing unit may be communicatively coupled to the elevator computing unit 220. The communication between the elevator motion control unit and the elevator computing unit 220 may be based on one or more known communication technologies, either wired or wireless. The communication between the cloud-based unit and the elevator computing unit 220 may be based on one or more known communication technologies, either wired or wireless.

At a step 320, the elevator computing unit 220 uses the obtained condition data 410 as input data of a reinforcement learning model 420. The reinforcement learning model 420 may be stored into a memory unit 720 of the elevator computing unit 220. The reinforcement learning model 420 is a machine learning model based on rewarding desired behaviors and/or punishing undesired one. The reinforcement learning model 420 may be provided to the elevator computing unit 220 with predefined initial model parameters and the reinforcement learning model 420 may then be trained during a commissioning of the method and/or during the use of the method.

At a step 330, the elevator computing unit 220 processes the input data, i.e. the condition data 410, with the reinforcement learning model 420 to produce, i.e. generate, output data comprising the load data 430 of the elevator car 110 representing an estimate of the load of the elevator car 110, i.e. a numerical estimation of the load of the elevator car 110. In other words, the elevator computing unit 220 is able to estimate the load data 430 of the elevator car 110 by applying the reinforcement learning model 420 with the obtained condition data. FIG. 4 illustrates schematically a simple example of the producing of the load data 430 by applying the reinforcement learning model 420 with the obtained condition data 410 used as the input data of the reinforcement learning model 420. Although, the estimate of the load of the elevator car 110 may be produced by using the reinforcement learning model 420 with the condition data 410 comprising one loading condition parameter, the more loading condition parameters and/or additional condition parameters the condition data comprises, the more accurate the produced estimate of the load of the elevator car 110 is. The use of the reinforcement learning model 420 to produce the load data 430 of the elevator car 110 enables adaptation to changing conditions on the configuration of the elevator system 100, changing conditions on the environment of the elevator system 100, and/or aging of the components of the elevator system 100.

At a step 340, the elevator computing unit 220 uses the produced load data 430 of the elevator car 110 in a controlling of the elevator system 100 and/or in a condition monitoring of the elevator car 100. The controlling of the elevator system 100 may for example comprise controlling the brakes of the hoisting machine 150, the drive unit and/or the hoisting motor 160. According to an example, the produced load data 430 of the elevator car 110 may be used by the drive unit to control the hoisting motor 160. The use of the produced load data of the elevator car 110 in the controlling of the elevator system 100 improves elevator ride comfort, e.g. by improving smoothness of a departure of the elevator car 110 from the loading landing. For example, for comparison the drive unit may provide measured load data of the elevator car 110 after the departure of the elevator car 110 from the loading landing, but this measured load data is obtained too late for improving the smoothness of the departure of the elevator car 110 from the loading landing. Using the produced load data 430 in the condition monitoring enables providing important information for the condition monitoring, which in turn improves the safety of the elevator system 100.

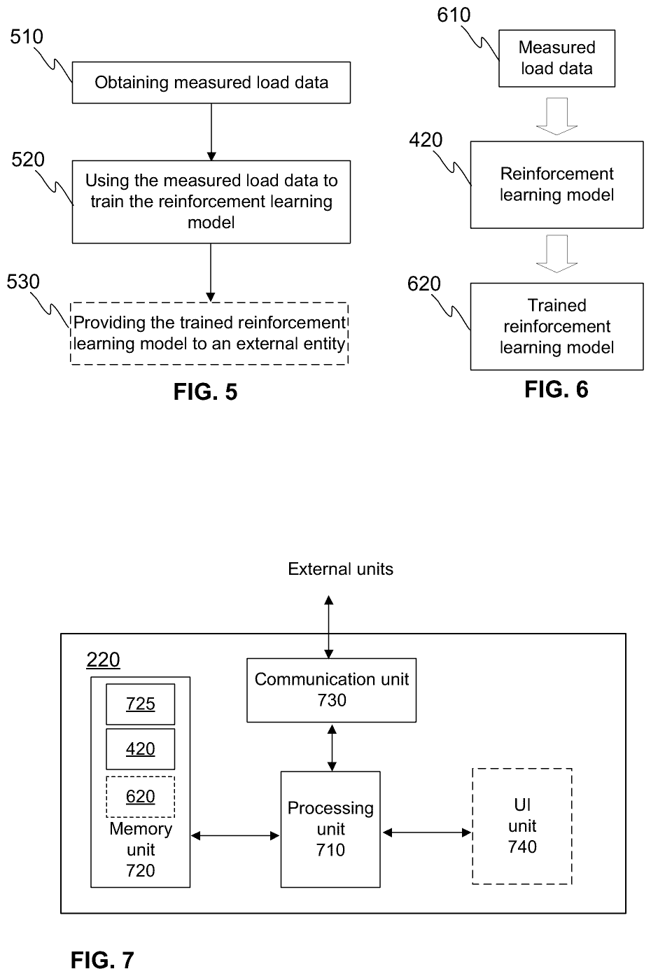

According to an example, the method may further comprise training the reinforcement learning model 420. FIG. 5 illustrates schematically an example of the method for producing the load data 430 of the elevator car 110 further comprising the training of the reinforcement learning model 420.

At a step 510, the elevator computing unit 220 obtains measured load data 610 of the elevator car 110 representing a measured load of the elevator car 100. The measured load data 610 of the elevator car 110 may be obtained from the drive unit after a departure of the elevator car 110 from the loading landing.

At the step 520, the elevator computing unit 220 uses the obtained measured load data 610 of the elevator car 110 to train the reinforcement learning model 420. FIG. 6 illustrates schematically a simple example of the training of the reinforcement learning model 420 by using the obtained measured load data 610. As a result of the training of the reinforcement learning model 420 a trained reinforcement learning model 620 may be generated. The trained reinforcement learning model 620 may be stored into the memory unit 720 of the elevator computing unit 220. The trained reinforcement learning model 620 may replace the previously stored reinforcement learning model 420. In other words, after the training, the trained reinforcement learning model 620 may be used in the producing of the load data of the elevator car 110 at the steps 320 and 330 of the method instead of the previously used reinforcement learning model 420. The measured load data 610 indicates accurately the actual load of the elevator car 110. Thus, the use of the measured load data 610 in the training of the reinforcement learning model 420 improves the accuracy of the trained reinforcement learning model 620.

According to an example, at a step 530 the trained reinforcement learning model 620 may further be provided to an external entity for further development of the trained reinforcement learning model 620 and/or for providing the trained reinforcement learning model 620 to one or more other elevator systems having substantially the same configuration and conditions as the elevator system 100 comprising the elevator car 110. For example, the elevator computing unit 220 may provide the trained reinforcement learning model 620 to the external entity, where the trained reinforcement learning model 620 may be further developed to enhance the trained reinforcement learning model 620 further and after the further development of the trained reinforcement learning model 620 it may be provided to one or more other elevator systems to be used for producing load data of at least one elevator car of said one or more other elevator systems. As the one or more other elevator systems have substantially the same configuration and conditions as the elevator system 100, the trained reinforcement learning model 620 and thus also the above-described method are compatible to be used with the one or more other elevator systems. The term “external” in the context of the entity means throughout this application an entity being external to the elevator system 100. The external entity may be located on-site and/or off-site. The external entity may for example comprise a server, a cloud server, remote server, computing circuit, and/or any other computing device or a network of computing devices being external to the elevator system 100.

FIG. 7 illustrates schematically an example of components of the elevator computing unit 220. The elevator computing unit 220 may comprise a processing unit 710 comprising one or more processors, a memory unit 720 comprising one or more memories, a communication unit 730 comprising one or more communication devices, and possibly a user interface (UI) unit 740. The mentioned elements may be communicatively coupled to each other with e.g. an internal bus. The memory unit 720 may store and maintain portions of a computer program (code) 725, the reinforcement learning model 420, the trained reinforcement learning model 620, the obtained condition data 410, the produced load data 430 of the elevator car 110, the obtained measured load data 610, and any other data. The computer program 725 may comprise instructions which, when the computer program 725 is executed by the processing unit 710 of the elevator computing unit 220 may cause the processing unit 710, and thus the elevator computing unit 220 to carry out desired tasks of the elevator computing unit 220, e.g. one or more of the method steps described above. The processing unit 710 may thus be arranged to access the memory unit 720 and retrieve and store any information therefrom and thereto. For sake of clarity, the processor herein refers to any unit suitable for processing information and control the operation of the elevator computing unit 220, among other tasks. The operations may also be implemented with a microcontroller solution with embedded software. Similarly, the memory unit 720 is not limited to a certain type of memory only, but any memory type suitable for storing the described pieces of information may be applied in the context of the present invention. The communication unit 730 provides one or more communication interfaces for communication with any other unit, e.g. the at least one sensor device 210, the drive unit, the external entity, one or more databases, or with any other unit. The user interface unit 740 may comprise one or more input/output (I/O) devices, such as buttons, keyboard, touch screen, microphone, loudspeaker, display and so on, for receiving user input and outputting information. The computer program 725 may be a computer program product that may be comprised in a tangible nonvolatile (non-transitory) computer-readable medium bearing the computer program code 725 embodied therein for use with a computer, i.e. the elevator computing unit 220.

The specific examples provided in the description given above should not be construed as limiting the applicability and/or the interpretation of the appended claims. Lists and groups of examples provided in the description given above are not exhaustive unless otherwise explicitly stated.

1. A method for producing load data of an elevator car of an elevator system, the method comprises:
obtaining condition data comprising at least one loading condition parameter being affected by the load of the elevator car, wherein the condition data is obtained during a loading event of the elevator car at a loading landing or during an elevator car movement cycle between a loading landing and a destination landing;
using the obtained condition data as input data of a reinforcement learning model;
processing the input data with the reinforcement learning model to produce output data comprising the load data of the elevator car representing an estimate of the load of the elevator car; and
using the produced load data of the elevator car in controlling of the elevator system and/or in condition monitoring of the elevator car.

2. The method according to claim 1, further comprising:
obtaining measured load data of the elevator car representing a measured load of the elevator car from an elevator drive unit after a departure of the elevator car from the loading landing, and
using the obtained measured load data of the elevator car to train the reinforcement learning model.

3. The method according to claim 2, further comprising providing the trained reinforcement learning model to an external entity for further development of the trained reinforcement learning model and/or for providing the trained reinforcement learning model to one or more other elevator systems having the same configuration and conditions as the elevator system.

4. The method according to claim 1, wherein the at least one loading condition parameter comprises a rope elongation value, a hoisting machine bedplate to a hoisting machine body distance value, and/or a hoisting machine tilt value.

5. The method according to claim 1, wherein the condition data further comprises at least one additional condition parameter.

6. The method according to claim 5, wherein the at least one additional condition parameter comprises landing data, an ambient temperature of the elevator car, an ambient humidity of the elevator car, and/or a number of starts of the elevator car.

7. The method according to claim 1, wherein the loading event starts from an opening of a door of the elevator car, and wherein the loading event ends to a closing of the door of the elevator car, an opening of brakes, or an activating a torque control to a drive unit.

8. An elevator computing unit for producing load data of an elevator car of an elevator system, the elevator computing unit comprising:
a processing unit comprising at least one processor; and
a memory unit comprising at least one memory including computer program code;
wherein the at least one memory and the computer program code are configured to, with the at least one processor, cause the elevator computing unit to perform:
obtain condition data comprising at least one loading condition parameter being affected by the load of the elevator car, wherein the condition data is obtained during a loading event of the elevator car at a loading landing or during an elevator car movement cycle between a loading landing and a destination landing;
use the obtained condition data as input data of a reinforcement learning model;
process the input data with the reinforcement learning model to produce output data comprising the load data of the elevator car representing an estimate of the load of the elevator car; and
utilize the produced load data of the elevator car in controlling of the elevator system and/or in condition monitoring of the elevator car.

9. The elevator computing unit according to claim 8, further configured to:
obtain measured load data of the elevator car representing a measured load of the elevator car from an elevator drive unit after a departure of the elevator car from the loading landing, and
use the obtained measured load data of the elevator car to train the reinforcement learning model.

10. The elevator computing unit according to claim 9, wherein the elevator computing unit is configured to provide the trained reinforcement learning model an external entity for further development of the trained reinforcement learning model and/or for providing the trained reinforcement learning model to one or more other elevator systems having the same configuration and conditions as the elevator system.

11. The elevator computing unit according to claim 8, wherein the at least one loading condition parameter comprises a rope elongation value, a hoisting machine bedplate to a hoisting machine body distance value, and/or a hoisting machine tilt value.

12. The elevator computing unit according to claim 8, wherein the condition data further comprises at least one additional condition parameter.

13. The elevator computing unit according to claim 12, wherein the at least one additional condition parameter comprises landing data, an ambient temperature of the elevator car, an ambient humidity of the elevator car, and/or a number of starts of the elevator car.

14. The elevator computing unit according to claim 8, wherein the loading event starts from an opening of a door of the elevator car, and wherein the loading event ends to a closing of the door of the elevator car, an opening of brakes, or an activating a torque control to a drive unit.

15. A load estimation system for producing load data of an elevator car of an elevator system, the load estimation system comprising:
at least one sensor device configured to provide condition data comprising at least one loading condition parameter being affected by the load of the elevator car, and
an elevator computing unit according to claim 8.

16. A non-transitory computer program product comprising instructions which, when the program is executed by a computer, cause the computer to carry out the method according to claim 1.

17. A non-transitory computer-readable medium comprising instructions which, when executed by a computer, cause the computer to carry out the method according to claim 1.

18. The method according to claim 2, wherein the at least one loading condition parameter comprises a rope elongation value, a hoisting machine bedplate to a hoisting machine body distance value, and/or a hoisting machine tilt value.

19. The method according to claim 3, wherein the at least one loading condition parameter comprises a rope elongation value, a hoisting machine bedplate to a hoisting machine body distance value, and/or a hoisting machine tilt value.

20. The method according to claim 2, wherein the condition data further comprises at least one additional condition parameter.
